(19) United States
(12) Patent Application Publication
(10) Pub. No.: US 2007/0009198 A1
(43) Pub. Date: Jan. 11, 2007

(54) Fiber optic bio-sensor

(76) Inventors: Robert Petcavich, Kirkland, WA (US); Xiaoping Simon Yang, Carlsbad, CA (US); Xuanqi John Zhang, Sunnyvale, CA (US); Dan Liang Jin, Bothell, WA (US); Nick Wolf, Covington, WA (US); Timothy M. Londergan, Seattle, WA (US); Diyun Huang, Bothell, WA (US); Galina K. Todorova, Seattle, WA (US)

Correspondence Address: FISH & RICHARDSON P.C., PO BOX 1022, MINNEAPOLIS, MN, 55440-1022, US

(21) Appl. No.: 11/174,123

(22) Filed: Jul. 1, 2005

Related U.S. Application Data
(60) Provisional application No. 60/585,064, filed on Jul. 2, 2004.

(51) Int. Cl. G02B 6/00

(52) U.S. Cl. 385/12

(57) ABSTRACT

A bio-sensor that includes (a) an optical fiber in which the surface of the fiber comprises a hydrogel polymer that includes a functional group comprising a first member of a binding pair; and (b) an excitation light source coupled to the fiber. When the fiber contacts a solution comprising a second member of the binding pair labeled with a light-emitting label, the first member binds to the second member, resulting in the emission of a detectable signal. Alternatively, the first member of the binding pair is provided with the light-emitting label.

### RELATED APPLICATIONS

This application claims the benefit of priority under 35 U.S.C. § 19(e) of Provisional Application No. 60/585,064 filed on Jul. 2, 2004.

### TECHNICAL FIELD

This invention relates to sensors for detecting biological molecules.

### BACKGROUND

A variety of assays for detecting the presence of biological molecules are known. Some assays rely upon binding between first and second members of a binding pair, one of which includes a light-emitting label. Examples of binding pairs include antigen-antibody pairs and the like. Examples of light-emitting labels include fluorescent labels. The fluorescent labels may be excited by using, for example, flood exposure, surface plasmon resonance, or evanescent fields from optical waveguides. Evanescent fields from optical waveguides have been used to excite fluorescent labels that are near sensor binding surface, thereby reducing the excitation of unbound fluorescent labels and increasing the signal to noise ratio. Both planar optical waveguides and optical fibers can be used. However, there is still a need for fiber optical sensors that have increase sensitivity, manufacturability, and ease of use.

### SUMMARY

In one aspect, a bio-sensor is described that includes (a) an optical fiber in which the surface of the fiber comprises a hydrogel polymer that includes a functional group comprising a first member of a binding pair; and (b) an excitation light source coupled to the fiber. When the fiber contacts a solution comprising a second member of the binding pair, the first member binds to the second member. The second member may further comprise a light-emitting label, e.g., a fluorescent label. The second member may also comprise an enzyme such as alkaline phosphatase, acid phosphatase, horseradish peroxidase, and tyrosinase. When the second member includes an enzyme, preferably the enzyme can react with a functional group on a fluorescent dye, for example alkaline phosphatase reacting with a phosphate containing dye and/or horseradish peroxidase reacting with a tryamide containing dye.

The first binding member may comprise biotin, a hapten, an antigen, an antibody, or an oligonucleotide. A specific example is bovine serum albumin. The second binding member may comprises a hapten, an antigen, or an antibody. Specific examples include avidin, streptavidin, and non-glycosylated avidin. Examples of suitable binding pairs include a biotin/avidin pair, a hapten/antibody pair, an antigen/antibody pair, or complementary strands of DNA or RNA. The functional group of the hydrogel polymer may be any chemical moiety that can bind to a biological molecule such as a protein, DNA, or RNA. The functional group may include, for example, biotin, a hapten, an antigen, an antibody, or an oligonucleotide. In all embodiments, a third member may bind the complex of the first member and second member.

In a second aspect, a bio-sensor is described that includes (a) an optical fiber in which the surface of the fiber comprises a hydrogel polymer that includes a functional group comprising a first member of a binding pair, and a light-emitting label; and (b) an excitation light source coupled to the fiber. When the fiber contacts a solution comprising a second member of the binding pair, the first member binds to the second member, resulting in the emission of a detectable signal.

In particular embodiments of the first and second aspects, the optical fiber is selected from the group consisting of plastic, glass, quartz, and silica fibers. Preferably, the optical fiber is patterned for multiple analysis areas, i.e. the fiber has a plurality of predetermined areas, each area having a different functional group. The width of the optical fiber is preferably wide enough to easily view with the naked eye, e.g., the fiber has a diameter between 0.5 mm and 2 mm. The optical fiber may be multi-mode, and may also have a circular, elliptical, or rectangular cross section. Preferably, the optical fiber is a D-fiber, or a side-polished fiber. With a D-fiber or a side polished fiber, the cladding of the fiber is selectively thinner in a predetermined area, which allows more light from the fiber core into the predetermined area. The excitation light source may include a light emitting diode (LED). The LED may operate at any wavelength that excites a predetermined fluorescent label. Typically, the LED wavelength is between 400 nm and 800 nm. Preferably, 1 to 3 portable, lightweight batteries such as AAA or AA batteries power the LED.

The hydrogel polymer may comprises units derived from acrylamide. For example, the hydrogel polymer may comprise a copolymer that includes units derived from (a) acrylamide and (b) an N-alkylamino acrylamide such as N-propylamino acrylamide.

In one embodiment, the first or second member of the binding pair may include biotin. In another embodiment, the first or second member of the binding pair may include bovine serum albumin. The light-emitting label may be a fluorescent label.

Also described are kits that include the biosensor and a solution comprising the second member of the binding pair. In some embodiments, the first member of the binding pair includes the light-emitting label, while in other embodiments, the second member of the binding pair includes the label.

Also described are methods for making a bio-sensor comprising: (a) coating an optical fiber with a hydrogel polymer; (b) bonding a first member of a binding pair to the polymer at one or more sites on the polymer to form a functionalized optical fiber; and (c) coupling a light source to the functionalized optical fiber. In some embodiments, the polymer further includes a light-emitting label.

The bio-sensors offer a number of advantages. The intensity of the detectable signal is sufficiently high that, in some cases, it may be observed by the naked eye. Thus, complex photodetectors are not needed.

The sensing capability of the sensor may be tuned by varying the thickness of the hydrogel coating, the number of first binding members, or both. In addition, individual fibers may be prepared with functionalized hydrogels specific to certain detection targets. Each of these fibers is usable with the same light source. Accordingly, the fibers may be readily switched for different detection purposes. The individual fibers may also be discarded after use, rendering the sensor disposable.

The bio-sensors are also portable and may be readily manufactured.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flow chart describing the preparation of an exemplary bio-sensor.

FIG. 2 is a graph of fluorescence intensity vs. wavelength for a biotinylated hydrogel-coated optical fiber and a non-biotinylated hydrogel-coated optical fiber.

Like reference symbols in the various drawings indicate like elements.

### DETAILED DESCRIPTION

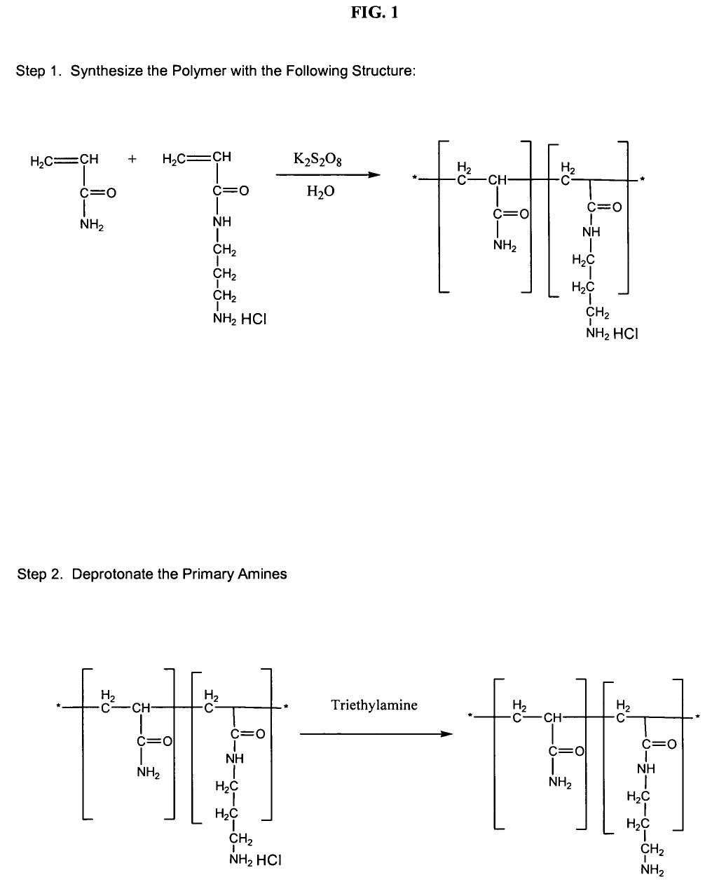

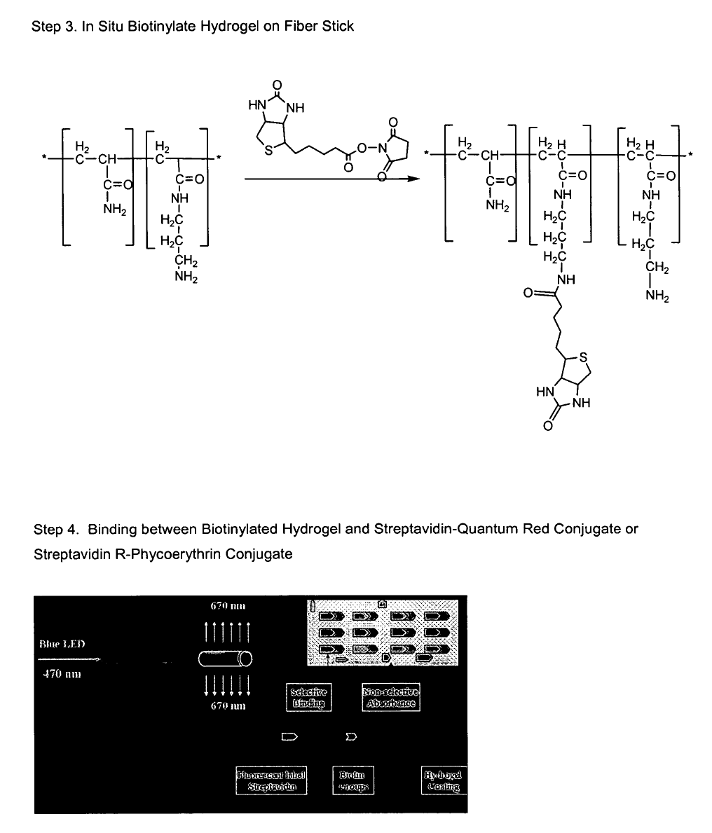

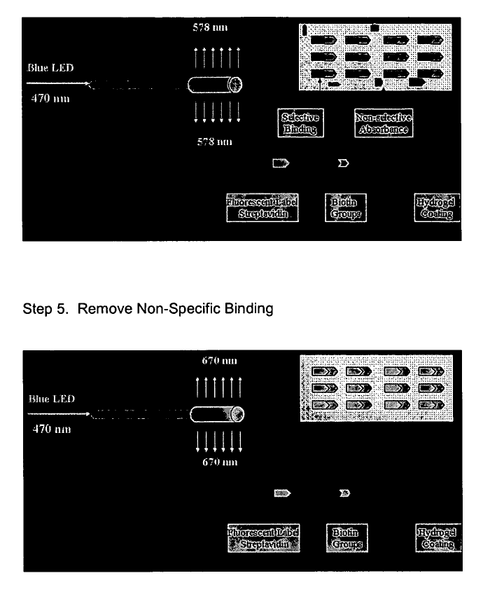

Referring to FIG. 1, a hydrogel polymer is synthesized via aqueous emulsion polymerization of acrylamide and N-propylamino acrylamide monomers using K₂S₂O₈ as the initiator. The resulting copolymer is prepared in the form of a hydrochloride salt. The copolymer is then neutralized with a base (e.g., triethylamine). Next, the copolymer is reacted with biotin in the presence of the optical fiber to both coat the fiber with the copolymer and to covalently bond the biotin groups to the copolymer via the amino groups of the copolymer. The number of biotin groups bonded to the copolymer may be adjusted by adjusting the relative stoichiometries of the copolymer and biotin molecules.

Biotin binds to a number of molecules, including bovine serum albumin (BSA) streptavidin. The BSA streptavidin, in turn, may be labelled with a light-emitting label. In FIG. 1, the label is either Quantum Red or R-Phycoerythrin, both of which are fluorescent labels. When the biotinylated fiber contacts a solution containing BSA streptavidin labelled with either Quantum Red or R-Phycoerythrin, the biotin and labelled BSA streptavidin molecules bind to each other, resulting in production of a detectable fluorescence signal.

### Example 1

A biotinylated, hydrogel-coated, optical fiber was immersed in a 1% solution of BSA streptavidin R-Phycoerythrin conjugate solution. As a control, an optical fiber coated with the hydrogel alone (i.e., the hydrogel without the covalently bound biotin molecules) was immersed in the same solution. Each fiber was immersed for several hours. Each fiber was then washed with phosphate buffered saline (PBS) to remove any non-specific binding from the hydrogel coating.

Next, each fiber was illuminated using an LED light source. When viewed in a dark box, both fibers emitted a detectable fluorescence signal. However, the intensity of the signal associated with the biotinylated fiber was significantly higher than the intensity of the signal associated with the non-biotinylated fiber.

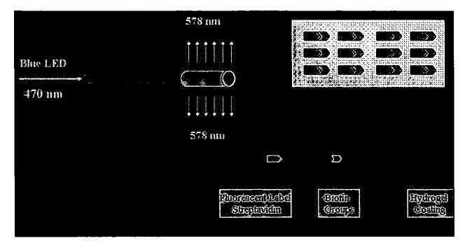

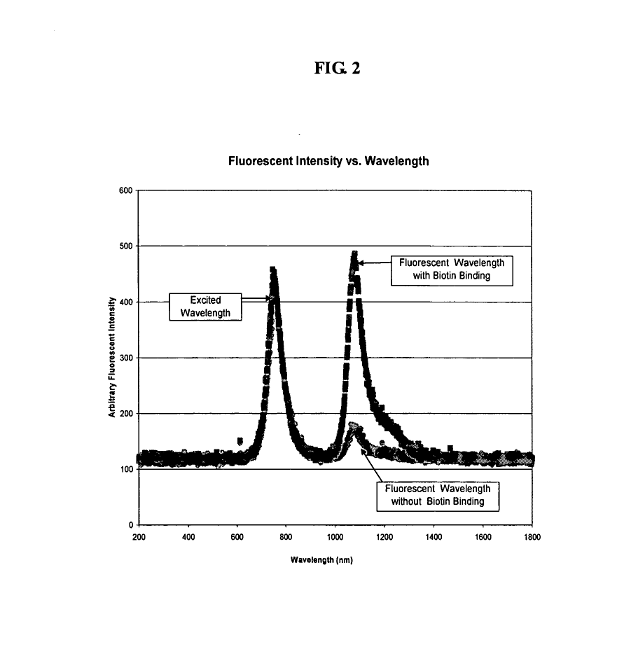

In order to quantify the light intensities, a spectrum analyzer was used to analyze the emitted light. The results are shown in FIG. 2. As shown in the figure, the fluorescence intensity associated with the biotinylated fiber is 5-6 times higher than the fluorescence intensity associated with the non-biotinylated fiber.

A number of embodiments of the invention have been described. Nevertheless, it will be understood that various modifications may be made without departing from the spirit and scope of the invention. Accordingly, other embodiments are within the scope of the following claims.

What is claimed is:

1. A bio-sensor comprising:
(a) an optical fiber in which the surface of the fiber comprises a hydrogel polymer that includes a functional group comprising a first member of a binding pair; and
(b) an excitation light source coupled to the fiber,
wherein when the fiber contacts a solution comprising a second member of the binding pair labeled with a light-emitting label, the first member binds to the second member, resulting in the emission of a detectable signal.

2. A bio-sensor comprising:
(a) an optical fiber in which the surface of the fiber comprises a hydrogel polymer that includes a functional group comprising a first member of a binding pair, and a light-emitting label; and
(b) an excitation light source coupled to the fiber,
wherein when the fiber contacts a solution comprising a second member of the binding pair, the first member binds to the second member, resulting in the emission of a detectable signal.

3. A bio-sensor according to claim 1 or 2 wherein the optical fiber is selected from the group consisting of plastic, glass, quartz, and silica fibers.

4. A bio-sensor according to claim 1 or 2 wherein the excitation light source comprises a light emitting diode (LED).

5. A bio-sensor according to claim 1 or 2 wherein the hydrogel polymer comprises units derived from acrylamide.

6. A bio-sensor according to claim 1 or 2 wherein the hydrogel comprises a copolymer that includes units derived from (a) acrylamide and (b) an N-alkylamino acrylamide.

7. A bio-sensor according to claim 6 wherein the N-alkylamino acrylamide is N-propylamino acrylamide.

8. A bio-sensor according to claim 1 or 2 wherein the first member of the binding pair comprises biotin, a hapten, an antigen, an antibody, or an oligonucleotide.

9. A bio-sensor according to claim 1 or 2 wherein the first member of the binding pair comprises bovine serum albumin.

10. A bio-sensor according to claim 1 or 2 wherein the second member of the binding pair comprises a hapten, an antigen, or an antibody.

11. A bio-sensor according to claim 1 or 2 wherein the second member of the binding pair comprises avidin, streptavidin, or non-glycosylated avidin.

12. A bio-sensor according to claim 1 or 2 wherein the second member of the binding pair comprises alkaline phosphatase, acid phosphatase, horseradish peroxidase, or tyrosinase.

13. A bio-sensor according to claim 1 or 2 wherein when the fiber contacts a solution comprising a second member of the binding pair, the first member binds to the second member, resulting in the emission of a detectable fluorescence signal.

14. A kit comprising:
(a) A bio-sensor comprising:
(i) an optical fiber in which the surface of the fiber comprises a hydrogel polymer that includes a functional group comprising a first member of a binding pair; and
(ii) an excitation light source coupled to the fiber; and
(b) a solution comprising a second member of the binding pair labeled with a light-emitting label,
wherein when the fiber contacts the solution, the first member binds to the second member, resulting in the emission of a detectable signal.

15. A kit comprising:
(a) A bio-sensor comprising:
(i) an optical fiber in which the surface of the fiber comprises a hydrogel polymer that includes a functional group comprising a first member of a binding pair, and a light-emitting label; and
(ii) an excitation light source coupled to the fiber; and
(b) a solution comprising a second member of the binding pair,
wherein when the fiber contacts the solution, the first member binds to the second member, resulting in the emission of a detectable signal.

16. A method of making a bio-sensor comprising:
(a) coating an optical fiber with a hydrogel polymer;
(b) bonding a first member of a binding pair to the polymer at one or more sites on the polymer to form a functionalized optical fiber; and
(c) coupling a light source to the functionalized optical fiber,
wherein when the fiber contacts a solution comprising a second member of the binding pair labeled with a light-emitting label, the first member binds to the second member, resulting in the emission of a detectable signal.

17. A method of making a bio-sensor comprising:
(a) coating an optical fiber with a hydrogel polymer;
(b) bonding a first member of a binding pair and a light-emitting label to the polymer at one or more sites on the polymer to form a functionalized optical fiber; and
(c) coupling a light source to the functionalized optical fiber,
wherein when the fiber contacts a solution comprising a second member of the binding pair, the first member binds to the second member, resulting in the emission of a detectable signal.

18. A method according to claim 16 or 17 wherein the hydrogel polymer comprises units derived from acrylamide.

19. A method according to claim 16 or 17 wherein the hydrogel comprises a copolymer that includes units derived from (a) acrylamide and (b) an N-alkylamino acrylamide.

20. A method according to claim 19 wherein the N-alkylamino acrylamide is N-propylamino acrylamide.
